(19) United States
(12) Patent Application Publication
(10) Pub. No.: US 2010/0211437 A1
(43) Pub. Date: Aug. 19, 2010

(54) Method and Device for Determining a Contact Point in Time for Contacting a Money Transfer System

(75) Inventors: Gerhard Schneider, Offenbach (DE); Frank Lenzner, Altenstadt (DE); Ute Marie-Kathrin Guenther, Darmstadt (DE); Alexander Martin, Modautal (DE)

Correspondence Address: HARNESS, DICKEY & PIERCE, P.L.C., P.O. BOX 828, BLOOMFIELD HILLS, MI, 48303, US

(73) Assignee: WINCOR NIXDORF INTERNATIONAL GMBH, Paderborn (DE)

(21) Appl. No.: 12/599,632

(22) PCT Filed: Oct. 31, 2007
(86) PCT No.: PCT/EP2007/061764

§ 371 Date: Nov. 10, 2009

(30) Foreign Application Priority Data
May 21, 2007 (DE) 10 2007 023 598.6

(51) Int. Cl. G06Q 10/00; G06N 5/02; G06Q 40/00

(52) U.S. Cl. 705/10; 706/52; 705/28

(57) ABSTRACT

The invention relates to devices and methods for determining a contact point in time for contacting a money transfer system, which comprise a data processing system to which data with information on the variation with time of the demand for supplying money to the money transfer system (22 to 50) and/or on the variation with time of the demand for removing money from the money transfer system (22 to 50) can be transmitted. Based on the variation with time of the demand, the data processing system determines at least one next demand point in time at which the money transfer system (22 to 50) has a demand for a supply and/or removal of money. Further, the data processing system performs an assessment method which, based on the determined demand point in time and at least one preset assessment criterion, determines and assesses several potential contact points in time at which money is supplied to the money transfer system (22 to 50) and/or at which money is removed from the money transfer system (22 to 50), the data processing system automatically determining a favorable contact point in time based on the assessment result of the assessment method. The data processing system outputs the determined favorable contact point in time or processes it further.

The invention relates to a method and a device for determining a contact point in time for contacting a money transfer system, in which a contact point in time is determined at which money is supplied to the money transfer system or money is removed from the money transfer system.

From document DE 699 30 126, a system for handling banknotes in a geographically limited area is known, in which so-called “disposable” cassettes are provided which include surplus banknotes. In contrast to cassettes with banknotes of minor quality or with false banknotes, the cassettes with the surplus banknotes are not transported to a national central bank. Further, an information center is provided to which a large number of banknote handling machines transfer information on the number of the banknotes which are deposited, drawn or withdrawn from circulation, the number of banknotes and their values which are present in the respective machines, the number of counterfeit banknotes which have been discovered, the number of banknotes with bad quality, and the number of available cassettes. The information center is also informed when banknotes have to be removed from a machine or banknotes have to be supplied.

In the prior art, money transfer systems, such as cash machines, bank branches, cash safes etc., are contacted by a value transport at regular time intervals or on a specific request of a branch in order to supply money, preferably banknotes, and/or to remove money from the money transfer system. As a result of the regular contacting of various money transfer systems, for example on defined weekdays, money is supplied and/or removed although at this contact point in time a supply or removal would not be necessary yet since the smooth operation of the money transfer system is still possible with the available money holdings. Also given a request to a value transport by an employee of a bank branch for a supply or a removal of money, the money holdings in the branch are usually determined by the employee, and the money demand for the following days is estimated. If the employee considers the supply and/or removal of money as being necessary, he/she contacts a higher authority, for example a value transport center in the bank or a value transport company (WTU) and requests the supply and/or the removal of money.

Further, the employee must take care of restrictions such as organizational instructions, which, for example, determine those weekdays at which it is agreed upon that a value transport will stop at the branch. The bank employee cannot determine at justifiable expense at which point in time a favorable delivery is possible, in particular when considering all delivery costs and the expenses for keeping money available that is not immediately required. As a result thereof, he/she can in particular not determine whether it is more favorable to fill a cash machine only once per week or twice per week in order to keep the total costs for the transport and the interests as low as possible. In the prior art, a coordination of the contact point in time with further money transfer systems which are assigned to one transport chain but lie outside of his/her branch cannot be taken into account by the bank employee in the determination of the contact point in time either. The postponement of the contact point in time to a later contact point in time than the one requested by the bank employee by a further decision-taking authority, for example, an information center of the bank, is not possible since at the information center the demand estimation for the money demand made by the bank employee is not known for individual days or time intervals but only for the time period between two defined contact points in time. Thus, a subsequent optimization is not possible in the prior art. In the prior art, the money is usually ordered by a facsimile sent by the bank employee to the value transport company (WTU) or to an authority in the bank coordinating the value transports.

It is the object of the invention to automatically determine with the aid of technical means a suitable contact point in time for contacting a money transfer system.

This object is solved by a method having the features of claim 1 or claim 13 and by a device having the features of claim 12 or claim 14. Advantageous developments of the invention are given in the dependent claims.

Both by a method for determining a contact point in time for contacting a money transfer system having the features of claim 1 as well as by a method for determining a contact point in time for contacting a money transfer system having the features of claim 13 it is achieved that an optimum contact point in time can be determined which takes into account both the demand of the money transfer system as well as at least one further assessment criterion in the selection of the optimum contact point in time from several potential contact points in time. The contact point in time is automatically determined, output and/or further processed with the aid of a data processing system. The money transfer system can be a cash dispensing machine, a cash deposit machine, a cash safe, a bank branch, a retail company and/or at least an automatic cash system. The contact point in time can be determined both for an individual money transfer system as well as for several money transfer systems which are assigned to one transport chain. In particular a day and/or a time period during a day is determined as a contact point in time at which the money transfer system is preferably contacted by a value transport, wherein money is supplied to the money transfer system or money is removed from the money transfer system given contact by the value transport. Alternatively, a point in time during a day can be determined up to when the money transport system should be contacted.

By means of a device for determining a contact point in time for contacting a money transfer system having the features of claim 12 or having the features of claim 14 the same advantages are achieved as by means of the method having the features of claim 1 or having the features of claim 13. Further, the devices and the method having the features of claim 13 can be developed in the same way as specified for the method according to claim 1, in particular by the dependent claims.

Further features and advantages of the invention result from the following description which in connection with the enclosed figures explains the invention in more detail with reference to an embodiment.

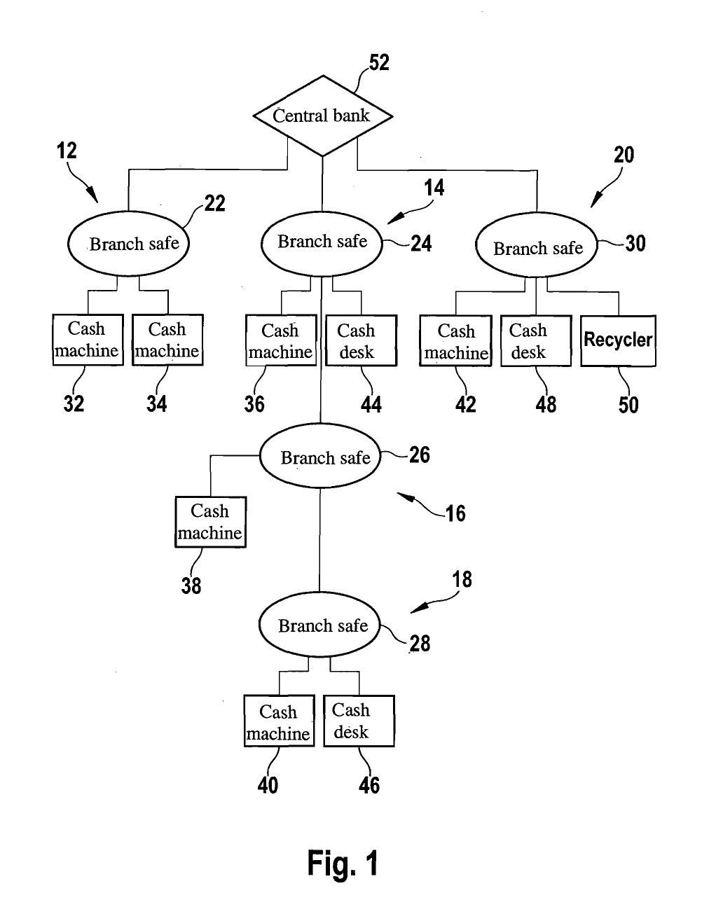

FIG. 1 shows a schematic overview of money transport paths of a bank.

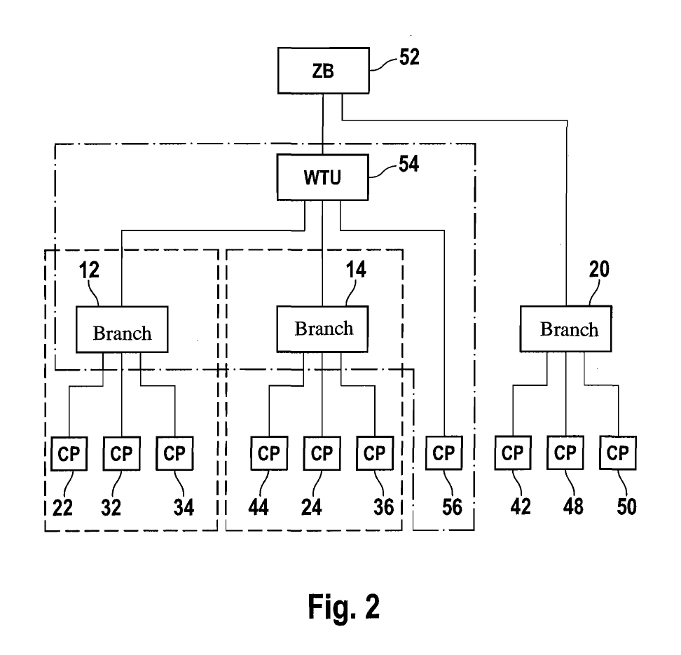

FIG. 2 shows a schematic illustration of the possible combination of individual money transfer systems to form transport chains.

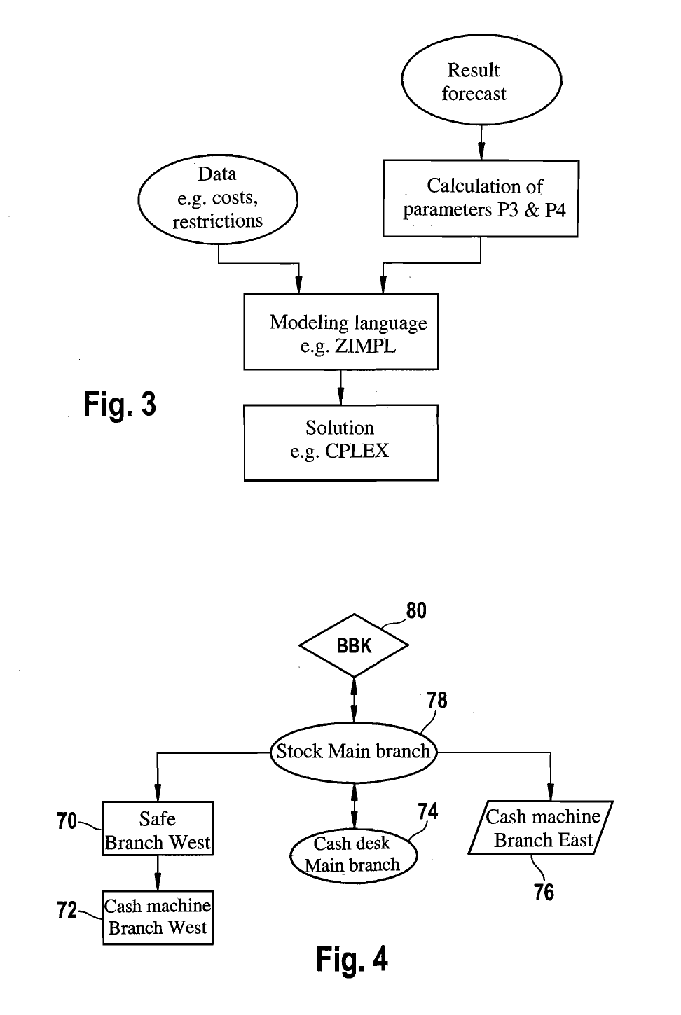

FIG. 3 shows the schematic sequence for determining appropriate contact points in time for contacting money transfer systems.

FIG. 4 shows a structure of money transfer systems of a bank, with the aid of the structure shown the procedure for determining optimum contact points in time for contacting the money transfer systems being exemplarily explained.

In FIG. 1, a schematic overview of exemplary money transport paths of cash flows 10 for the transport of money, such as banknotes and coins, to and from bank branches 12, 14, 16, 18, 20 is illustrated. The branches 12 to 20 are preferably part of a branch network of a bank or a credit institute. The branch 12 has a branch safe 22 as well as two cash machines 32, 34. The branch 14 has a branch safe 24 as well as a cash machine 36 and a cash desk 44. The branch 16 has a branch safe 26 as well as a cash machine 38. The branch 18 has a branch safe 28 as well as a cash machine 40 and a cash safe 46. Further, the branch 20 has a branch safe 30 as well as a cash machine 42, a cash safe 48 and a recycler 50. The cash machines 32 to 42 as well as the branch safes 22 to and the recycler 50 can be opened both by bank employees of the respective branch 12 to 20 as well as by attendants of a value transport which transports money to and from the branch 12 to 20, at least such that each time money to be removed can be removed and money to be supplied can be reliably deposited. The money is transported with the aid of the value transport from a central bank 52 (ZB), such as a Land Central Bank, from the Federal Bank (BBK) or from a central money reservoir of the bank or a value transport company (WTU) to the branches 12, 14, 20 or, respectively, from the branches 12, 14, 20 to the central bank 52. Further, money is transported between the branches 14 and 16 as well as between the branches 16 and 18 with the aid of a value transport or another safe transport by bank employees, for example within a secured building, in order to effect a required exchange of money. The transport paths between the central bank 52 and the branches 12 to 20 form the basis for the cash flow 10. The safes, cash machines, cash systems and recyclers 22 to 50 are also referred to as money transfer systems or cash points (CP). These money transfer systems 22 to 50 comprise both pure cash dispensing systems, such as cash machines 32 to 42, as well as cash deposit and dispensing systems, such as cash desks 44 to 48 and recycler 50. Usually, cash points 22 to 50 are filled and emptied by a service provider, such as a value transport company (WTU). The money for filling the cash points 22 to 50 is provided by a so-called cash center, such as the central bank 52. The cash flow 10 does not always take place directly between a cash center 52 and a cash point 22 to 50 but can also take place via one or more intermediate storage locations. Such intermediate storage locations can, for example, also be the branch safes 22 to 30 of the branches 14 to 18.

It is desirable to minimize the costs incurred by the bank for the transport of the money along the money transport paths 10 as well as the holding costs for providing the money for filling the cash points 22 to 50 and for keeping the money available in the cash points 22 to 50. The costs are in particular composed of the transport costs when a value transport stops at a cash point 22 to 50, the handling costs for filling or emptying the cash point 22 to 50 and the interest charges for providing money in the cash points 22 to 50 and the storage of the money in safes. Further, penalty fees can be fixed fictitiously, which represent the dissatisfaction of the customers when certain money, for example one denomination, is not available in a cash point 22 to 50. The amount of these penalty fees can, for example, be determined by the estimated advertising expense which is necessary for the compensation of the image damage caused with respect to customers who have not been served in a satisfactory way and/or by the banking transaction which is reduced as a result of unsatisfactory customers and is to be compensated for by newly acquired customers.

Further, technical and organizational requirements may have to be taken into account as secondary conditions for the optimization. These requirements can in particular relate to business days which can be both predetermined on part of the bank branches 12 to 20 as well as by days on which value transports are carried out. Further, delivery terms may have to be taken into account, as a result whereof respective handling times are to be provided when determining a suitable delivery point in time. Further, technical and organizational filling quantities have to be taken into account when filling the cash points 22 to 50, by which filling quantities, in particular by packing units, filling quantity steps of the cash points 22 to 50 are determined. Further, it has to be taken into account that a defined number of value transports per day is possibly not to be exceeded and/or a distribution—as uniform as possible—of the value transports over agreed upon business days or a concentration of the value transports to defined business days takes place.

Further requirements for contacting the cash points 22 to 50 can be provided so that the supply is guaranteed. In particular, a minimum filling time period can be determined in which the cash point and/or the safe 22 to has to be contacted at least once or the value transport has to stop by. Further, fixed routes can be provided so that a stop is made at a cash point and/or safe 22 to 50 at previously defined days so that at least the transport costs have to be spent even if the cash point or safe 22 to 50 is not contacted by the value transport and thus in particular no handling costs are incurred.

In addition, further requirements resulting from security gaps, for example, for reasons pursuant to insurance law, or additional costs when the money holdings of a cash point or safe exceeds a predetermined value can be taken into account in an optimization. Such restrictions which are not purely technically conditioned, can also be exceeded or not taken into account in the individual case, wherein this non-observance of a restriction is taken into account in the assessment by way of penalty points or penalty costs in an assessment method for assessing different potential contact points in time. Additionally or alternatively to the assessment of individual denominations in the cash point or safe 22 to 50, a penalty can be raised only and/or additionally be raised when the total money holdings of a cash point or safe 22 to 50 is too high or the total holdings are equal to zero.

Further, it is common practice that value transport companies (WTU) grant discounts when at least a certain number of cash points 22 to 50 is to be contacted on one day. For example, there is a discount of 10% when a stop is to be made at least 10 cash points or branches 12 to 50. Further, a discount of 20% can be granted for a stop at 20 cash points per day, with a discount of 30% being usually granted at most.

In order to minimize the costs incurred by contacting a cash point or safe 22 to 50 for supplying or removing money, a contact point in time is determined for each cash point 32 to 50, each safe 22 to 30 and/or each branch 12 to 20, as well as the amount to be supplied or the removal to be expected of all denominations of the respective cash points 32 to 50, safes 22 to 30 or the respective branch 12 to 20 is determined. In the following, the cash machines, the cash safes, the branch safes and the recyclers are all generally combined under the term cash point 22 to 50. When a cash point 22 to 50 is supplied with money, which at the point in time of supply still has a stock of money, unnecessary interests have been paid for the money present in the cash point 22 to 50. This is true at least for the amount of money which exceeds a predetermined safety amount in the cash point 22 to 50. Thus, too much money has been supplied to the cash point 22 to 50 at the time of delivery at a previous contact point in time. Accordingly, one can speak of an optimum delivery when the money holdings in the cash point 22 to 50 are exactly consumed up to the next contact point in time or the safety amount has been reached. If the respective cash point 22 to 50 is, for example, a recycler 50, in which in addition to the withdrawal of money also a deposit of money is possible, then only so much money has to be supplied at a contact point in time that all withdrawals forecast by a forecast algorithm can be made and further withdrawals can be made with the aid of the money supplied in the meantime. It is advantageous when, at a later point in time, only the safety amount is present in the cash point 22 to 50 or no more money is present in the cash point 22 to 50. At least it is advantageous when, in addition to the safety amount, no further money supplied at the previous contact point in time is present at the next contact point in time in the cash point 22 to 50 but only money that has possibly been deposited.

Preferably, the money to be supplied at a contact point in time is fixed depending on the money required up to a next fixed contact point in time. As a result thereof, the amount of money to be supplied is fixed when the delivery dates, i.e. the contact points in time, are fixed. The exact penalty costs which may be incurred if a cash point 22 to 50 cannot be charged in due time owing to other requirements can likewise be determined. With the aid of the optimization algorithm explained in more detail in the following optimum contact points in time can be fixed as delivery dates at which money is supplied to the cash points 22 to 50 or money is removed from the cash points 22 to 50. In doing so, it is advantageous to combine several cash points 22 to 50 to one group, as exemplarily shown in FIG. 2. In contrast to FIG. 1, the structure shown in FIG. 2 comprises still another cash point 56 not located in a bank branch 12 to 20, which is, for example, set up at a gas station or in a shopping mall as a cash dispensing machine or recycler. Further, a money transfer point 54 is provided between the central bank 52 and the branches 12, 14 to be supplied with money, as well as the cash points 22, 32, 34, 24, 36, 44 associated with these branches 12, 14 as well as the additional cash point 56. The central bank 52 directly delivers money to the branch 20 with the cash points 30, 42, 48, 50. The delivery comprises both the supply and the removal of money.

If several cash points are located at one location, for example in a bank branch, the transport costs for the delivery of the individual cash points of this bank branch are only charged once and handling costs are additionally charged for each cash point. The cash points at one location, for example, the cash points 22, 32, 34 of the bank branch 12, and the cash points 24, 36, 44 of the bank branch 14 are each combined to one group, as indicated by the broken lines in FIG. 2. Further, the branch 12, the branch 14 and the additional cash point 56 are combined to one superordinate group which is assigned to a joint transport chain. The transport chain comprises those branches where successive stops by the value transport are made and which are preferably also contacted. For optimizing the contact points in time and the amounts of money to be supplied and/or to be removed, several future contact points in time are determined, the amount of the money to be supplied being fixed such that it is exactly consumed at the day of the next delivery at least when no money is deposited at the cash point. Thus, the filling of the cash points has to be performed such that, owing to the forecast on the money demand and the deposits at the cash point, it is sufficient for the time period between the two successive contact points in time. In doing so, it is advantageous to distinguish between the denominations of individual cash points and to provide a different delivery of the cash points.

In the schematic illustration shown in FIG. 2, for example, at first an optimum delivery to the cash points 22, 32, 34 present within the broken line is calculated. As a result thereof, the demand of the branch 12 as well as the demand of a single cash point can be dealt with in the further consideration and further optimization. In the next step, an optimization of the demand of the branches 12, 14 and of the single cash point 56 is performed, as a result whereof a multi-level grouping and optimization takes place. The grouping of the cash points 22, 32, 34 of the branch 12 and the grouping of the cash points 24, 36, 44 of the branch 14 can preferably take place in parallel in order to the reduce the total calculating time.

In the following, a mixed integer program is explained which can preferably be used for determining optimum contact points in time and money amounts. For each cash point, the money demand of a cash point is forecast with daily precision and/or up to a predetermined time of day with the aid of a so-called forecast module. For making the forecast, the forecast module uses the demand acquisition for the respective cash point over a significant reference period of preferably at least one calendar year, taking into account special calendar days like weekdays, holidays and other predictable special events, in particular major events. If a demand acquisition over a suitable reference period is not available for a cash point and/or if the expense for the forecast of the demand is to be reduced, the demand acquisition for a further cash point having a similar expected demand can be used as a basis for the forecast of the demand of the respective cash point.

For the forecast of the demand of a cash point, the forecast module outputs the following parameter classes P1 and P2 as a forecast result.
P1: αₜ^{i,d} Number of units of denomination d expected to be withdrawn in cash point i on day t;
P2: βₜ^{i,d} Number of units of denomination d expected to be deposited in cash point i on day d;

Based on the parameter classes P1 and P2, the parameter classes P3 and P4 are determined.
P3: ξₜ_{₁}_{,t}_{₂}^{i,d}εZ Number of units of denomination d to be supplied on day t₁ to cash point i when the next stop at the cash point takes place on the day d₂. If no money has to be supplied since sufficient deposits are made before a withdrawal is made or no withdrawals are made at all, then ξₜ_{₁}_{,t}_{₂}^{i,d}=0;
P4: φₜ_{₁}_{,t}_{₂}^{i,d}εZ Number of units of denomination d to be collected from cash point i on day t₂ when the stop at the cash point has taken place for the last time on day t₁. If there is no money in the cash point on day t2, then φₜ_{₁}_{,t}_{₂}^{i,d}=0;

The costs for contacting and keeping money available as well as the penalty costs are represented by the following parameters P5 to P9:
P5: δₜⁱ Transport costs for a stop at the cash point i on day t by the WTU;
P6: δₜ^{WTU} Transport costs for delivery from Federal Bank to the safe of the WTU on day t;
P7: γₜ^{i,d} Handling costs incurred by supplying the cash point i with denomination d on day t;
P8: λ Interest rate to be paid for the money present in cash points;
P9a: pₜ^{i,d} Penalty costs to be paid if denomination d runs empty in the cash point i on day t;
P9b: p̅ₜ^{i,d} Penalty costs to be paid if denomination d fills to overflow in cash point i on day t;

Further, other secondary conditions are taken into account in the embodiment as restrictions P10 to P13:

$$P 10 \text{:} {μ}_{t}^{i} = \{ \begin{matrix}1 , & if cash point i can be delivered on day t ; \\ 0 , & otherwise ;\end{matrix}$$

P11: max^{WTU,d} Maximum stock capacity for denomination d in the safe of the WTU;
P12: max^{i,d} Maximum capacity for denomination d in the cash point i;
P13: ω Maximum number of cash points at which a stop can be made per day by the WTU;

Further, the number of days for which a delivery strategy, i.e. optimized contact points in time, are to be determined are preset as parameter P14.
P14: D Number of days for which a delivery strategy is to be calculated;

Based on parameters P1 to P14, the following parameters are determined which are then inserted into an objective function for optimization:

$$V 1 \text{:} {s}_{t}^{i , d} \begin{matrix}Number of units of denomination d present in the \\ cash point i at the beginning of day t ;\end{matrix}$$

$$V 2 a \text{:} {\underline{y}}_{t}^{i , d} = \{ \begin{matrix}1 , & \begin{matrix}if the denomination d in cash point \\ i on day t does not run empty ; \end{matrix} \\ 0 , & otherwise ;\end{matrix} \\ V 2 b \text{:} {\overline{y}}_{t}^{i , d} = \{ \begin{matrix}1 , & \begin{matrix}if the denomination d in the cash point \\ i on day t does not fill to overflow ;\end{matrix} \\ 0 , & otherwise ;\end{matrix} \\ V 3 \text{:} {s}_{t}^{WTU , d} \begin{matrix}Number of units of denomination \\ d present in the safe of the WTU \\ at the beginning of day t ;\end{matrix} \\ V 4 \text{:} {x}_{{t}_{1} , {t}_{2}}^{i} = \{ \begin{matrix}1 , & \begin{matrix}if CP i is supplied to or emptied \\ on day t 1 and then on day t 2 ;\end{matrix} \\ 0 , & otherwise ;\end{matrix} \\ V 5 \text{:} {w}_{t}^{i} = \{ \begin{matrix}1 , & if cash point i is supplied to on day t ; \\ 0 , & otherwise ;\end{matrix} \\ V 6 \text{:} {w}_{t}^{WTU} = \{ \begin{matrix}1 , & \begin{matrix}if there is a delivery on day t from \\ the BBK to the safe of the WTU ;\end{matrix} \\ 0 , & otherwise ;\end{matrix} \\ V 7 \text{:} {l}_{t}^{WTU , d} \begin{matrix}Number of units of denomination d \\ which are supplied on day t \\ from the BBK to the safe of the WTU ;\end{matrix}$$

It results therefrom that the costs to be minimized are comprised of the interest costs, the transport and handling costs, the penalty costs given a filling to overflow or running empty of a cash point, the costs for the stocking of cash in the safe of an intermediate storage, in particular in the safe of the value transport company (WTU), and the costs for the delivery to the safe of the intermediate storage location by a central bank. Based on this recognition, the minimum value W of the formula

$$W = λ {\sum }_{t , i , d}^{ } {ds}_{t}^{i , d} + {\sum }_{t , i}^{ } ( {δ}_{t}^{i} + {\sum }_{d}^{ } {γ}_{t}^{i , d} ) {w}_{t}^{i} + {\sum }_{t , i , d}^{ } ( {\underline{ρ}}_{t}^{i , d} ( 1 - {\underline{y}}_{t}^{i , d} ) + {\overline{ρ}}_{t}^{i , d} ( 1 - {\overline{y}}_{t}^{i , d} ) ) + λ {\sum }_{t , d}^{ } {ds}_{t}^{WTU , d} + {\sum }_{t}^{ } {δ}_{t}^{WTU} {w}_{t}^{WTU}$$

is to be determined.

In doing so, it is to be checked that the following secondary conditions N1 to N12 are met:
N1: The maximum number of cash points at which a stop can be made in one day must not be exceeded.

$$∀ t \text{:} {\sum }_{i}^{ } {w}_{t}^{i} \leq ω$$

N2: In the safe of the WTU at least as much cash must be present has to be delivered.

$$∀ t , d : {s}_{t}^{WTU , d} \geq {\sum }_{t < {t}_{1} , i}^{ } {ξ}_{t , {t}_{1}}^{i , d} {x}_{t , {t}_{1}}^{i}$$

N3: The maximum capacity of the safe of the WTU must not be exceeded.

∀t,d:max^{WTU,d}≧sₜ^{WTU,d}
N4: The maximum capacity of a cash point must not be exceeded.

∀t,d,i:max^{i,d}≧sₜ^{i,d}
N5: The cash stock of a cash point on two successive days must be consistent.

$$∀ t , i , d : {s}_{t + 1}^{i , d} = {s}_{t}^{i , d} + {\sum }_{{t}_{1} > t}^{ } {ξ}_{t , {t}_{1}}^{i , d} {x}_{t , {t}_{1}}^{i} - {\sum }_{{t}_{1} < t}^{ } {ϕ}_{{t}_{1} , t}^{i , d} {x}_{{t}_{1} , t}^{i} - {\underline{y}}_{t}^{i , d} {α}_{t}^{i , d} + {\overline{y}}_{t}^{i , d} {β}_{t}^{i , d}$$

N6: The stock of a cash point cannot be negative.

∀t,i,d:sₜ^{i,d}≧0
N7: The cash stock in the safe of the WTU on two successive days must be consistent. It is assumed that the deliveries always take place at the end of a day.

$$∀ t , d : {s}_{t + 1}^{WTU , d} = {s}_{t}^{WTU , d} - {\sum }_{{t}_{1} > t , i}^{ } {ξ}_{t , {t}_{1}}^{i , d} {x}_{t , {t}_{1}}^{i} + {\sum }_{{t}_{1} < t , i}^{ } {ϕ}_{{t}_{1} , t}^{i , d} {x}_{{t}_{1} , t}^{i} + {l}_{t}^{WTU , d}$$

N8: The stock of the safe of the WTU cannot be negative.

∀t,d:sₜ^{WTU,d}≧0
N9: A cash point cannot be filled up or emptied if it cannot be delivered.

∀t,i:wₜⁱ≦μₜⁱ
N10: The variables which model the supply to and the removal from a cash point must be consistent.

$$∀ t , i : {\sum }_{{t}_{1} > t}^{ } {x}_{t , {t}_{1}}^{i} = {w}_{t \\}^{i}$$

$$∀ t , i : {\sum }_{{t}_{1} < t}^{ } {x}_{{t}_{1} , t}^{i} = {w}_{t \\}^{i}$$

N11a: The variable which models the running empty of a denomination of a cash point must be activated if not enough notes of the respective denomination are present in the cash point.

∀t,i,d:sₜ^{i,d}−yₜ^{i,d}αₜ^{i,d}≧0
N11b: The variable which models the filling to overflow of a denomination of a cash point must be activated if too many notes of the respective denomination are present in the cash point.

∀t,i,d:sₜ^{i,d}+ y̅ₜ^{i,d}βₜ^{i,d}≦max^{i,d}
N12: The variable which indicates whether the safe of the WTU is filled by the Federal Bank at a specific day must be consistent with the variable which indicates the quantity of the delivery.

∀t,d:lₜ^{WTU,d}≦max^{WTU,d}wₜ^{WTU}

In the following, further parameters and secondary conditions are given for various versions. When taking into account a predetermined minimum filling period, the optimization model illustrated is extended as follows:
P15: τⁱ Minimum filling period for the cash point i;
N13: The predetermined minimum filling period has to be adhered to.

$${\sum }_{t ∈ s ( i )}^{ } {w}_{t \\}^{i} \geq 1$$

$$with$$

$$∀ i : S ( i ) = \{ \{ k , k + 1 , … k + {τ}^{i} \} \vert k ∈ \{ 1 , 2 , … , D - {τ}^{i} \} \} .$$

In the determination of a fixed route, the variables V4 and V5 can be set accordingly and thus be taken into account as parameters in the optimization model. If, for example, the cash point i is to be supplied to or emptied on the second and the fifth weekday, then

w₂^{o}=w₅ⁱ=x_{2,5}ⁱ=1

The other values of the variables V4 and V5 are set to zero.

In order to take the penalty costs per cash point into account, the following parameters and variables are modified as follows:

Parameters:
P9a′: ρₜⁱ Penalty costs to be paid if the cash point i runs empty on day t;
P9b′: ρ̅ₜⁱ Penalty costs to be paid if the cash point i fills to overflow on day t;
P9c′: ρ_{Soft}_{ₜ}ⁱ Penalty costs to be paid if cash point exceeds the soft barrier on day t;
P12′: maxⁱ Maximum total capacity of cash point i;
P16: softlimitⁱ Upper soft barrier, with penalty costs being incurred if exceeded;
P17: minⁱ Corrected lower safety stock for cash point i.

Variables:

$$V 2 {a}^{′} \text{:} {\underline{y}}_{t}^{i} = \{ \begin{matrix}1 , & \begin{matrix}if cash point i does \\ not run empty on day t .\end{matrix} \\ 0 , & otherwise ;\end{matrix} \\ V 2 {b}^{′} \text{:} {\overline{y}}_{t}^{i} = \{ \begin{matrix}1 , & \begin{matrix}if cash point i does \\ not fill to overflow on day t ;\end{matrix} \\ 0 , & otherwise ;\end{matrix} \\ V 2 {c}^{′} \text{:} {y}_{{Soft}_{t}^{i}} = \{ \begin{matrix}1 , & \begin{matrix} if cash point i does not exceed \\ soft barrier on day t ;\end{matrix} \\ 0 , & otherwise ;\end{matrix}$$

In order to take the penalty costs per cash point into account, by minimizing the value W of the function

$$w = λ {\sum }_{t , i , d}^{ } {ds}_{t}^{i , d} + {\sum }_{t , i}^{ } ( {δ}_{t}^{i} + {\sum }_{d}^{ } {γ}_{t}^{i , d} ) {w}_{t}^{i} + {\sum }_{t , i}^{ } ( {\underline{ρ}}_{t}^{i} ( 1 - {\underline{y}}_{t}^{i} ) + {\overline{ρ}}_{t}^{i} ( 1 - {\overline{y}}_{t}^{i} ) + {ρ}_{{Soft}_{t}^{i}} ( 1 - {y}_{{Soft}_{t}^{i}} ) ) + {+ \sum }_{t , i , d}^{ } ( {\underline{ρ}}_{t}^{i , d} ( 1 - {\underline{y}}_{t}^{i , d} ) + {\overline{ρ}}_{t}^{i , d} ( 1 - {\overline{y}}_{t}^{i , d} ) ) + λ {\sum }_{t , d}^{ } {ds}_{t}^{WTU , d} + {\sum }_{t}^{ } {δ}_{t}^{WTU} {w}_{t}^{WTU}$$

an optimum contact point in time is determined.

For this, the following secondary conditions in N11a′, in N11b′, in N11c′ and N4′ are to be taken into account:
N11a': The variable which models the running empty of a cash point must be activated if not enough money is present in the cash point.

$$∀ t , i : {\sum }_{d}^{ } {ds}_{t + 1}^{i , d} - {min}^{i} {\underline{y}}_{t}^{i} \geq 0$$

In order to prevent that the algorithm sets yₜⁱ to zero, even if notes are still present in the container, the following secondary condition is added (M being a very large number):

sₜ^{i,d}−αₜ^{i,d}≦M*yₜⁱ
N11b′: The variable which models the filling to overflow of a cash point must be activated when too much money is present in the cash point.

$$∀ t , i : {\sum }_{d}^{ } {ds}_{t + 1}^{i , d} - ( 1 - {\overline{y}}_{t}^{i} ) M \leq {max}^{i}$$

M has to be a large number and can be set equal to

$${\sum }_{d}^{ } {max}^{i , d} * d$$

In order to prevent that the algorithm sets yₜⁱ to zero, even if the capacity of the container is not yet exhausted, the following secondary condition is added (M is a very large number):

max^{i,d}−sₜ^{i,d}−βₜ^{i,d}≦M* y̅ₜⁱ
N11c′: The variable which models the exceeding of the soft barrier must be activated when too much money is present in the cash point.

$$∀ t , i : {\sum }_{d}^{ } {ds}_{t + 1}^{i , d} - ( 1 - {y}_{{Soft}_{t}^{i}} ) M \leq {softlimit}^{i}$$

N4′: The maximum capacity of a cash point must not be exceeded.

$$∀ t , i : {max}^{i} \geq {\sum }_{d}^{ } {s}_{t}^{i , d}$$

For taking into account the discounts, the variable V9 can be provided.
V9:

$$\frac{{r}_{t}^{i}}{10}$$

Percent discount on the transport costs which are granted upon a stop at the cash point i on day t.

Based thereon, the minimum of the value W of the function

$$w = λ {\sum }_{t , i , d}^{ } {ds}_{t}^{i , d} + {\sum }_{t , i}^{ } ( {δ}_{t}^{i} + {\sum }_{d}^{ } {γ}_{t}^{i , d} ) {w}_{t}^{i} + {\sum }_{t , i , d}^{ } ( {\underline{ρ}}_{t}^{i , d} ( 1 - {\underline{y}}_{t}^{i , d} ) + {\overline{ρ}}_{t}^{i , d} ( 1 - {\overline{y}}_{t}^{i , d} ) ) + λ {\sum }_{t , d}^{ } {ds}_{t}^{WTU , d} + {\sum }_{t}^{ } {δ}_{t}^{WTU} {w}_{t}^{WTU} - 0.1 {\sum }_{t , i}^{ } {r}_{t}^{i} {σ}_{t}^{i}$$

is to be determined.

In doing so, the following secondary conditions N15 to N17 are further to be taken into account:
N15: A discount can only be given if a stop is made at the cash point at all.

∀t,i:wₜⁱ≧rₜⁱ
N16: Altogether sufficient cash points must be stopped at.

$$∀ t , j : \frac{1}{10} {\sum }_{i}^{ } {w}_{t}^{i} \geq {r}_{t}^{i}$$

N17: There is a maximum discount of 30%.

∀t,j:rₜ^{j}≦3

The optimization of the contact points in time and of the money amounts is explained in more detail in the following with the aid of the block diagram shown in FIG. 3. A forecast result is determined for each cash point on the basis of stored statistic values with the aid of a forecast algorithm. Based thereon, the calculation of parameters P3 and P4 takes place. These parameters as well as further data required for the assessment and the optimization, such as costs incurred when contacting a cash point, and further restrictions are converted into a modeling language, such as the modeling language ZIMPL. Based on the data transferred into the module, the solution of the optimization algorithm indicated by the module is, for example, solved with the aid of a CPLEX calculation module. The calculation module then determines the minimum of the respective optimization sum and the contact points in time and the money amounts on which this sum is based, and outputs these as an optimization result. The predefined secondary conditions are taken into account in the determination of the optimization result. In particular, optimization sums which are based on data which do not fulfill at least one necessary secondary condition are not taken into account in the determination of the minimum. Alternatively, on the basis of the data which do not fulfill at least one necessary secondary condition no optimization sum can be formed, as a result whereof the required calculation expense for calculating the optimization sums can be reduced.

When calculating the parameter P4, it is further to be taken into account that only money can be removed from a cash point 22 to 50 which has not been withdrawn beforehand.

With the aid of the following table, the demand of the recycler 50 for banknotes is explained exemplarily for banknotes having a denomination of EUR 50.00:

| Day | Withdrawals | Deposits |
|---|---|---|
| 1 | 300 | 0 |
| 2 | 0 | 200 |
| 3 | 0 | 200 |
| 4 | 200 | 0 |
| 5 | 300 | 0 |

It has to be determined how many banknotes of this denomination of EUR 50.00 must be deposited in the recycler 50 on day 1 at which the recycler 50 is contacted by a value transport so that, taking into account the deposits, all withdrawals up to day 5 are possible, at which the recycler 50 is again contacted by the value transport. In order to meet the demand for the presumable withdrawals, at day 1 300 banknotes have to be supplied. On day 2 and day 3, 200 banknotes each of this denomination are deposited. On day 4 200 banknotes and on day 5 300 banknotes are requested by withdrawals so that the sum of the withdrawals exceeds the sum of the previous deposits on day 5 by 100 banknotes. These 100 banknotes must be supplied to the recycler 50 in addition to the 300 banknotes when the delivery to the recycler takes place on day 1 so that altogether 400 banknotes of this denomination have to be supplied to the recycler 50 on the delivery day 1. If, at any point in time in the period between the delivery on day 1 and the delivery on day 5, the sum of the deposits is higher than the sum of the withdrawals, no banknotes have to be supplied to the recycler 50 so that it has to be checked whether the recycler 50 is to be contacted at all on day 1. This may be necessary if it is determined that owing to deposits an amount of money is present in the recycler 50 that is to be removed from the recycler 50.

When the optimal contact points in time or, respectively, delivery dates have been determined, the money amounts B to be actually supplied can be calculated for a day t2 as follows:

B=ξₜ_{₂}ₜ_{₃}−φₜ_{₁}_{,t}_{₂},

with t1, t2 and t3 being three successive stop dates, i.e. contact points in time of a cash point 22 to 50. Given a positive result, money has to be supplied to the cash point 22 to 50, and given a negative result money has to be withdrawn from the cash point 22 to 50. The actual amount of money to be supplied may then be adapted to the packing unit determined by the secondary conditions, in particular by predetermined cassette sizes.

If, at the beginning of a time period, for which contact points in time are to be fixed, money is still present in a cash point 22 to 50, this has to be taken into account in the calculation of the amount of delivery for this cash point 22 to 50. The initial stock is then to be interpreted as deposit on day 1 and thus is to be added to parameter P2. For explanation purposes, the following fictitious example is described hereinafter:

A cash machine has an opening stock of 500 banknotes. The amount of withdrawal is 300 banknotes per day. In the following table, parameters P3 and P4 calculated on the basis of these initial conditions are given.

| Day t₁ | Day t₂ | ξ_{t1,t2} | φ_{t1,t2} |
|---|---|---|---|
| 0 | 1 | 0 | 500 |
| 0 | 2 | 0 | 200 |
| 0 | 3 | 0 | 0 |
| 0 | 4 | 0 | 0 |
| 0 | 5 | 0 | 0 |
| 0 | 6 | 0 | 0 |
| 1 | 2 | 300 | 0 |
| 1 | 3 | 600 | 0 |
| 1 | 4 | 900 | 0 |
| 1 | 5 | 1200 | 0 |
| 1 | 6 | 1500 | 0 |
| 2 | 3 | 300 | 0 |
| 2 | 4 | 600 | 0 |
| 2 | 5 | 900 | 0 |
| 2 | 6 | 1200 | 0 |
| 3 | 4 | 300 | 0 |
| 3 | 5 | 600 | 0 |
| 3 | 6 | 900 | 0 |
| 4 | 5 | 300 | 0 |
| 4 | 6 | 600 | 0 |
| 5 | 6 | 300 | 0 |

As a result, the optimization algorithm suggests day 1 and day 4 as delivery points in time, i.e. as contact points in time. The delivery quantity on day 1

ξ_{1,4}−φ_{0,1}=400

banknotes and the delivery quantity on day 4

ξ_{4,6}−φ_{1,4}=600

banknotes.

In order to explain the optimization with the aid of the optimization algorithm in more detail, a clear example scenario is explained in connection with FIG. 4.

The calculation for optimization preferably takes place in two stages, as already explained in connection with FIG. 2. In the embodiment according to FIG. 4, at first the demand of the safe 70 and of the cash machine 72 of the branch West are calculated and combined in one group. The optimum filling strategy for the branch West is calculated. The result of this optimization is then used as a demand in the further optimization together with the demand of the cash desk 74 of the main branch and the cash machine 76 of the branch East. From the total demand of the stock 78 of the main branch which is comprised of the demand of the branch West, the demand of the cash desk 74 of the main branch and the cash machine 76 of the branch East, the demand of the stock 78 of the main branch is determined, an optimization of the filling of the stock 78 of the main branch being determined by calling money from the Federal Bank (BBK) 80.

As a planning period used for the optimization, a time period of at least five, preferably at least seven days has proven favorable. However, given even greater optimization periods of fourteen days or four weeks, further optimizations can be achieved, in particular given a large number of cash points to be considered.

For the cash points shown in FIG. 4, the following delivery dates result for a planning period of fourteen days:
Day 1: Delivery from stock of main branch (HF) to branch East
Day 2: Delivery from the BBK to the stock of the HF
Day 3: Delivery from stock of HF to cash desk of HF and to branch West
Day 5: Delivery from stock of HF to cash desk of HF
Day 6: Delivery from stock of HF to cash desk of HF
Day 7: Delivery from safe to cash machine of branch West
Day 9: Delivery from BBK to stock of HF
Day 11: Delivery from stock of HF to branch East

For making this delivery, total costs in the amount of EUR 1,183.79 are incurred given a total of eight rides without further restrictions. If, in addition, the restriction is taken into account that no delivery is to take place on a weekend, nine rides are necessary and costs in the amount of EUR 1,437.05 are incurred. If in the alternative the restriction is given that at most one delivery per day and no delivery on weekends takes place, then altogether ten rides are necessary resulting in costs in the amount of EUR 1,468.32.

1. A method for determining a contact point in time for contacting a money transfer system,
in which data with information on the variation with time of the demand for supplying money to the money transfer system and/or on the variation with time of the demand for removing money from the money transfer system are transmitted to a data processing system,
in which with the aid of the data processing system, based on the variation with time of the demand, at least one next demand point in time is determined, at which the money transfer system has a demand for supplying and/or removing money,
in which the money transfer system is assigned to a transport chain,
in which with the aid of the data processing system at least one further next demand point in time of at least one further money transfer system assigned to the transport chain is determined, at which the further money transfer system has a demand for supplying and/or removing money, or in which a further next demand point in time of at least one further money transfer system assigned to the transport chain is transmitted to the data processing system, at which a demand of the further money transfer system for supplying and/or removing money is expected,
in which with the aid of the data processing system an assessment method is performed with the aid of which, based on the determined demand points in time and at least one preset assessment criterion, several potential contact points in time at which money is supplied to the money transfer system and/or money is removed from the money transfer system are determined and assessed, a contact point in time that is favorable based on the assessment result of the assessment method being automatically determined, and
in which the determined favorable contact point in time is output and/or further processed by the data processing system.

2. The method according to claim 1, wherein the money transfer system is a cash dispensing machine, a cash deposit machine, a cash safe, a bank branch, a retail company and/or at least an automatic cash system.

3. The method according to claim 1, wherein for determining the first and/or at least the second demand point in time a time series analysis is performed, in which the actual variation with calendar of the demand for the respective money transfer system and/or a comparable money transfer system in the past is determined, preferably taking into account fluctuations of the actual demand that have occurred and/or that are to be expected.

4. The method according to claim 1, wherein the variation with time of the demand is determined from the statistical acquisition of the actual demand over a representative period in time, preferably over at least one calendar year, with the aid of the or a further data processing system.

5. The method according to claim 1, wherein the demand point in time is determined such that at the determined demand point in time a preset amount of money is still present in the money transfer system as a withdrawal capacity for withdrawal with a preset probability and/or that at the determined demand point in time a preset free banknote storage as a deposit capacity for the deposit of money in the money transfer system is available with a preset probability.

6. The method according to claim 1, wherein as a further assessment criterion, there serves
the potential contact points in time contractually agreed upon with at least one transport company,
the costs for actually used contact points in time, the possibly agreed upon different costs for agreed upon potential contact points in time,
the interests for the supplied money from the contact point in time up to the demand point in time and/or other costs when the contact point in time lies before the demand point in time,
the interests for the money not yet removed from the money transfer system, the probability of the complete consumption of the money of one denomination present in the money transfer system,
the probability of the complete consumption of the money of all denominations present in the money transfer system,
the loss of confidence of the customers given a complete consumption of the money of one denomination,
the loss of confidence of the customers given a complete consumption of the money of all denominations, and/or
the probability of the complete filling of the money that can be deposited in the money transfer system.

7. The method according to claim 6, wherein assessment points are assigned to the one or each assessment criterion, preferably as costs, the assessment method performing an assessment for different potential contact points in time and determines the contact point in time, the assessment points of which represent the minimum expense.

8. The method according to claim 1, wherein the contact point in time and/or the demand points in time specify a calendar day or a time period of a calendar day, preferably morning, afternoon, evening and/or night.

9. The method according to claim 1, wherein the money transfer systems assigned to the transport chain and having the same determined contact point in time are assigned to a value transport tour, the money transfer systems assigned to a value transport tour being output together with the contact point in time and preferably the required amounts of money to be supplied and preferably being automatically transferred to a value transport company (WTU).

10. The method according to claim 1, wherein the money transfer system and the further money transfer system are contacted at the contact point in time, money according to the demand of the respective money transfer system being supplied to the money transfer system and/or being removed from the money transfer system.

11. The method according to claim 1, wherein the data with information on the variation with time of the demand for supplying money to the money transfer system and/or to the further money transfer system and/or on the variation with time of the demand for removing money from the money transfer system and/or from the further money transfer system is provided by a data bank system and/or is determined from the data provided by a data bank system.

12. A device for determining a contact point in time for contacting a money transfer system, comprising:
with a data processing system,
to which data with information on the variation with time of the demand for supplying money to the money transfer system and/or on the variation with time of the demand for removing money from the money transfer system can be transmitted,
which, based on the variation with time of the demand, determines at least one next demand point in time at which the money transfer system has a demand for supplying and/or removing money,
which assigns the money transfer system to a transport chain,
which determines at least one further next demand point in time of at least one further money transfer system assigned to the transport chain, at which the further money transfer system has a demand for supplying and/or removing money, or at which a further next demand point in time of at least one further money transfer system assigned to the transport chain is transmitted to the data processing system, at which a demand of the further money transfer system for a supply and/or removal of money is expected,
which performs an assessment method, which, based on the determined demand points in time and at least one preset assessment criterion, determines and assesses several potential contact points in time at which money is supplied to the money transfer system and/or at which money is removed from the money transfer systems, the data processing system automatically determining a favorable contact point in time based on the assessment result of the assessment method, and
which outputs the determined favorable contact point in time and/or further processes it.

13. A method for determining a contact point in time for contacting a money transfer system, comprising:
in which data with information on the variation with time of the demand for supplying money to the money transfer system and/or on the variation with time of the demand for removing money from the money transfer system is transmitted to a data processing system,
in which with the aid of a data processing system, based on the variation with time of the demand, at least one next demand point in time is determined, at which the money transfer system has a demand for a supply and/or removal of money,
in which with the aid of the data processing system an assessment method is performed, with the aid of which, based on the determined demand point in time and at least one preset assessment criterion, several potential contact points in time at which money is supplied to the money transfer system and/or at which money is removed from the money transfer system are determined and assessed, a contact point in time that is favorable based on the assessment result of the assessment method being automatically determined, and
in which the determined favorable contact point in time is output and/or further processed by the data processing system.

14. A device for determining a contact point in time for contacting a money transfer system, comprising:
with a data processing system,
to which data with information on the variation with time of the demand for supplying money to the money transfer system and/or on the variation with time of the demand for removing money from the money transfer system can be transmitted,
which, based on the variation with time of the demand, determines at least one next demand point in time, at which the money transfer system has a demand for a supply and/or a removal of money,
which performs an assessment method, which, based on the determined demand point in time and at least one preset assessment criterion, determines and assesses several potential contact points in time at which money is supplied to the money transfer system and/or at which money is removed from the money transfer system, a favorable contact point in time being automatically determined by the data processing system based on the assessment result of the assessment method, and
which outputs and/or further processes the determined favorable contact point in time.
